(19) United States
(12) Patent Application Publication
(10) Pub. No.: US 2014/0196621 A1
(43) Pub. Date: Jul. 17, 2014

(54) ROTARY OFFSET PRINTING MACHINE AND METHOD FOR PRINTING ON SUBSTRATES

(71) Applicants: Georg Riescher, Joessnitz (DE); Anton Hamm, Neusaess (DE); Josef Hammer, Augsburg (DE); Norbert Dylla, Schwaebisch Hall (DE); Eduard Hoffmann, Bobingen (DE)

(72) Inventors: Georg Riescher, Joessnitz (DE); Anton Hamm, Neusaess (DE); Josef Hammer, Augsburg (DE); Norbert Dylla, Schwaebisch Hall (DE); Eduard Hoffmann, Bobingen (DE)

(73) Assignee: manroland web systems GmbH, Augsburg (DE)

(21) Appl. No.: 14/114,492

(22) PCT Filed: Apr. 29, 2011
(86) PCT No.: PCT/EP11/02140

§ 371 Date: Mar. 13, 2014

(51) Int. Cl. B41F 3/02

(52) U.S. Cl. CPC B41F 3/02
USPC 101/217; 101/492

(57) ABSTRACT

A method and apparatus for printing on a printing material web is disclosed. A rotary offset printing machine includes a printing unit with two plate cylinders and a blanket cylinder. The blanket cylinder prints on the printing material web and the two plate cylinders are arranged relative to each other such that respective images from the two plate cylinders are transferred to an identical position on the blanket cylinder during the printing.

### TECHNICAL FIELD

Embodiments of the subject matter described herein relate generally to a rotary offset printing machine and a method for printing on substrates, and more particularly, embodiments of the subject matter relate to a rotary offset printing machine, and a method for printing on textile substrates.

### BACKGROUND

Printing of recurring patterns or images on a more or less endless printing material web is a well known standard procedure, for instance when printing newspapers, which is mostly done on web-fed rotary offset printing machines due to their high printing capacity. The term “endless” is usually referred to the length of a web which is rolled on to a reel, or the recurring patterns printed on the printing material web which occur to be endless since these patterns or images are printed without any or very little gap between consecutive patterns. The web material is usually any kind of paper-based material, cardboard, packaging material, wallpapers, or foils made of any kind of material. Other materials for printing may include fabric or textile materials, for instance for production of apparel and/or interior or furnishing items. Such textile materials or substrates are conventionally printed using sheet fed, silk screen or digital inkjet printing technologies. Particularly with respect to apparel or fashion items, there is an increasing demand for such items worldwide since the number of people is constantly growing and changes in fashion causes people to buy new items regularly.

Prior art document DE 407369 discloses a rotary offset printing machine for printing on textile webs, wherein the printing machine comprises two impression cylinders and, corresponding to each impression cylinder, two transfer or blanket cylinders with respective plate cylinders assigned to them. A web of textile material can be guided between the first impression cylinder and its respective two transfer or blanket cylinders and then between the second impression cylinder and its respective two transfer or blanket cylinders. In order to achieve a transfer of prints, i.e. images or patterns, onto the web without a gap between consecutive individual prints, which is particularly desirable for printing on textiles or wallpapers, the two transfer cylinders assigned to each impression cylinder are arranged in a certain distance from each other. This ensures that prints assigned to the first impression cylinder are more or less exactly mating with the following prints assigned to the second impression cylinder.

As mentioned above, for printing on textiles or generally on substrates where a regularly recurring pattern shall be achieved, for the reason of high printing capacities in order to satisfy the growing demand, it is desirable to provide a rotary offset printing machine and a method for printing without gaps or misalignments between the individual prints. However, it is also very important to achieve prints with high accuracy or sharpness of the printed images with a high degree of details which may be more pleasing to the human eye than blurry images. High printing capacities as mentioned above means in particular “high speed” of the printing machine for mass textile printing, which implies a reduction of prize of items or articles, which may be printed in a wide variety of colors according to the needs of the market. Also, it is important to achieve relatively high environmentally friendly production of printed textiles which in some instances and/or locations in the world are produced based on rather old technologies where production workers come in direct contact with at least harmful substances which may also pollute the environment.

### BRIEF SUMMARY

In accordance with one embodiment, a method for printing on a printing material web by using a rotary offset printing machine is provided, wherein the rotary offset printing machine comprises at least one printing unit having at least two plate cylinders, the method comprising the following steps: providing the printing material web having a first side and a second side; wherein the printing material web is treated to reduce or avoid an inherent relative movement to itself; feeding the printing material web into and through the at least one printing unit; and printing on the first side of the printing material web by means of a blanket cylinder on which respective images from the at least two plate cylinders have been transferred onto, wherein the at least two plate cylinders are arranged relative to each other with respect to their operation such that the images from the at least two plate cylinders are transferred to an identical position on the blanket cylinder.

In accordance with another embodiment, a rotary offset printing machine for printing on a printing material web is provided, wherein the rotary offset printing machine comprises: at least one printing unit, comprising: at least two plate cylinders; at least one transfer cylinder; at least one impression cylinder arranged opposite to the at least one transfer cylinder; and at least one inking unit corresponding to one of the at least two plate cylinders; wherein the at least two plate cylinders are arranged relative to each other with respect to their operation such that images from the at least two plate cylinders are transferred to an identical position on the blanket cylinder; and wherein the at least one printing unit is configured to print on the printing material web, which is treated to reduce or avoid an inherent relative movement to itself. The at least one inking unit may be, throughout this document, of the type used for offset sheetfed-, offset commercial- and/or offset newspaper-printing presses. Also, an anilox or waterless offset inking unit could be used.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic side view of a rotary offset printing machine in accordance with one embodiment;

FIG. 2 is a detailed view of a section of the rotary offset printing machine shown in FIG. 1 in accordance with one embodiment; and

FIG. 3 is a schematic cross-sectional view of printing material substrate or web for use with the rotary offset printing machine of FIG. 1 in accordance with one embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

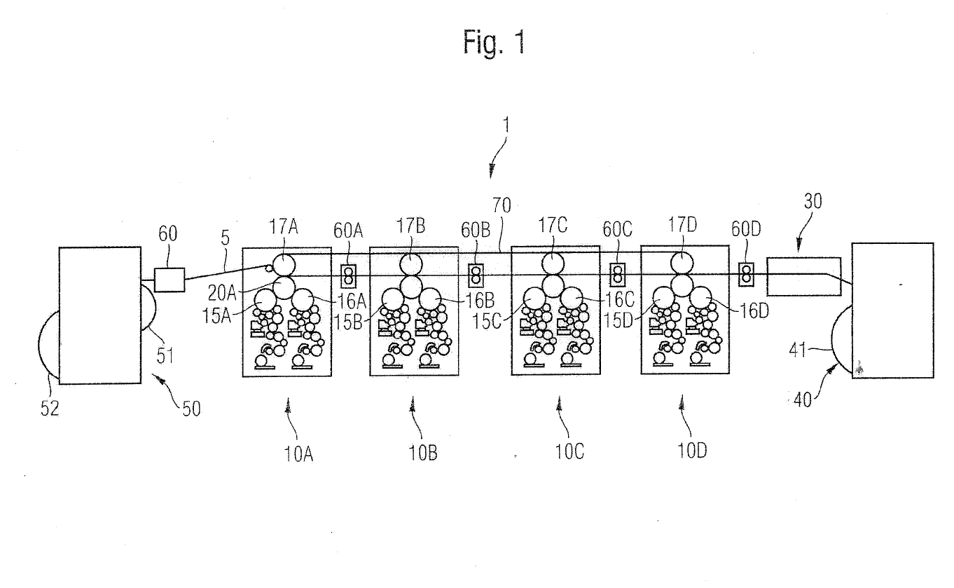

FIG. 1 depicts an exemplary embodiment of a rotary offset printing machine 1. The rotary offset printing machine 1 includes, without limitation, a roll-off feeder unit 50, a web tension control unit 60, four print units 10A, 10B, 100. 10D, a dryer unit 30 and a rewind reel unit 40. As is commonly known, roll-off feeder unit 50 comprises at least one reel 51 for providing a substrate to be printed on. In the example shown in FIG. 1, roll-off feeder unit 50 comprises a second reel 52 for automated reel change, as is also well known.

As is shown in FIG. 1, a printing material web 5 is rolled off from reel 51, and then guided through web tension control unit 60 into first print unit 10A for printing first images or patterns onto web 5, then into second print unit 10B for printing second images or patterns onto web 5, then into third print unit 10C for printing third images or patterns onto web 5, and then into fourth print unit 10D for printing fourth images or patterns onto web 5. It shall be noted that first, second, third and fourth images or patterns may be identical in terms of information contained therein but each image or pattern may be printed in a different color so that a multi-colored image on web 5 is finally achieved. A more detailed description of print units 10A-10D will be given below. It is understood that rotary offset printing machine 1 may comprise any number of print units, including only one print unit, and may be of modular design for modifying the rotary offset printing machine as may be required by the user. It is also understood that rotary offset printing machine 1 may be of a type used for waterless offset printing. However, instead of offset printing technologies as described herein, other printing technologies with raised or recessed printing elements, such as flexographic printing or gravure printing for example, may be combined with the disclosed invention.

Still with reference to FIG. 1, after the fourth image(s) has been printed onto web 5 in print unit 10D, the web 5 is guided through web dryer unit 30 for drying the colors on web 5, as is commonly known. The web dryer unit 30 may be of infrared (IR), hot air or any other known or future type. After web dryer unit 30, web 5 is rolled on to a reel 41 in rewind reel unit 40, for further processing of the printed web 5, for example for manufacturing apparel etc. Alternatively, although not shown in the Figures, dryer unit 30 may be omitted. In this case, printed colors on web 5 may be cured in an alternative way, such as by applying a curing agent or the like. It is also noted that roll-off feeder unit 50 and/or rewind reel unit 40 are not necessary to implement the invention. Other methods of providing an endless printing material web and collecting (i.e. rolling on to a reel) of the printed material web are conceivable.

It is noted that tension of web 5 is controlled by means of web tension control unit 60, and additionally, without limitation, by means of further web tension control unit components 60A, 608, 60C, 60D, which are well known in the art and shall therefore not be explained here in detail.

Still with reference to FIG. 1, there is also shown a belt 70 which is an endless belt driven by one of or all of impression cylinders 17A, 17B, 17C, 17D of respective print units 10A-10D. The function of belt 70 is to support i.e. to guide web 5 while web 5 is being printed in print units 10A-10D and being moved from one print unit to the other. In order to provide appropriate guidance and/or support for web 5, belt 70 may comprise on its surface, which is in con tact with web 5, for example a layer of rubber material or any other material which is suitable to provide appropriate adhesive forces to web 5 for guidance and movement of web 5.

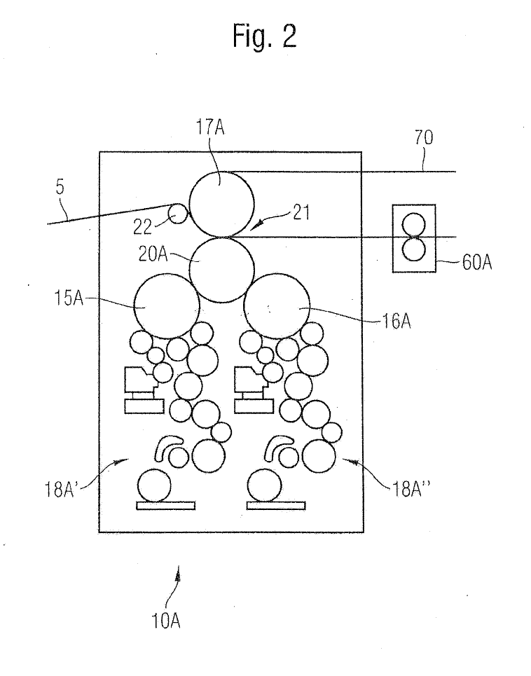

Print units 10A-10D will now be described with reference to FIG. 1 and FIG. 2. It is noted that in the example shown in FIG. 1 for the sake of brevity print units 10A-10D are identical in design and function, but may of course be variable and different from print unit to print unit depending on respective user requirements. Therefore even though the following detailed description is given only with respect to print unit 10A, the description shall also be applicable to print units 10B-10D or any other number of print units present or conceivable to be present in the rotary offset printing machine 1.

In an exemplary embodiment print unit 10A comprises a plate cylinder 15A and a plate cylinder 16A, as well as a transfer (or blanket) cylinder 20A and an impression cylinder 17A. The terms transfer cylinder and blanket cylinder are used synonymously in this document, and may be of the sleeve type as is known in the art. With respect to FIG. 2 which is a detailed view of print unit 10A from FIG. 1 there is also shown an inking unit 18A′ assigned to plate cylinder 15A and an inking unit 18A″ assigned to plate cylinder 16A. Inking units 18A′ and 18A″ are well known in the art and may also each comprise a dampening system or systems for application of other materials for finishing, stabilizing, sealing or otherwise treating the surface of web 5 to be printed. It is understood that cylinders 15A and 16A may be of the plate cylinder type as shown in FIG. 1 and FIG. 2, but may also be of a direct imaging type (for example as a gravure cylinder). Images on cylinder 15A and 16A are being transferred on to transfer cylinder 20A, and from there onto web 5 at gap position 21 which is defined by transfer cylinder 20A and impression cylinder 17A. Web 5 is guided by a roller 22 to bring web 5 into contact with belt 70 which is wound around impression cylinder 17A. Web tension control unit element 60A provides the required tension for the web comprising web 5 and belt 70.

It is noted, that, throughout this document, cylinder 20A may also be of the type comprising a rubber sleeve (compressible/incompressible), which is well known in the art, or cylinder 20A may be made fully of rubber material.

In the exemplary embodiment the information of the image to be printed is partly contained on plate cylinder 15A and partly contained on plate cylinder 16A. However, the ratio of image information contained on cylinder 15A and on cylinder 16A may not be fixed, but may vary, for example 49% of image information on cylinder 15A and 51% of image information on cylinder 16A. Other ratios are also conceivable. A distribution of the image information between the two cylinders 15A and 16A provides a more accurate display of the image printed on web 5, and also provides a better rendering of overlapping of consecutive images which improves the impression of an “endless” print. The term “information” refers to the printing dots present on the plate cylinders 15A/16A or a printing plate on cylinders 15A/16, i.e. the more dots are present the higher the available information is and vice versa.

In the exemplary embodiment inking units 18A′ and 18A″ contain ink of identical color. With respect to FIG. 1 each print unit 10A, 10B, 10C, 10D prints with a different color or ink. However, as mentioned above, a lesser number of different colors is also conceivable, as is the use of materials for finishing or otherwise preparing or treating the printed web 5, for instance with a varnish or other finishing or preserving material or substance.

Although not shown in the Figures, it is also possible that one or all of the print units 10A-10D comprise only one inking unit which then provides ink to both of the plate cylinders 15A/16A, 15B/16B, 15C/16C, 15D/16D, respectively. Alternatively, there may be one or more additional inking units or application units in each of the print units 10A-10D.

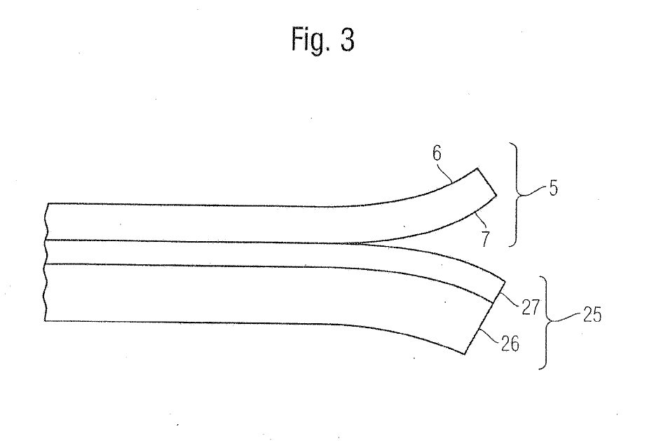

In an exemplary embodiment, FIG. 3 shows schematically a cross section of a portion of printing material web 5. As can be seen, web 5 comprises a layer 6 having a first side 7 and a second side 8. Layer 6 shall be referred to as printing material web throughout the document (and is used synonymously to web 5) since it is the layer on which images are printed, i.e. on the first side 7 of layer 6. Furthermore, web 5 comprises a carrier material web 25 including a first layer 26 and a second layer 27. First layer 26 and second layer 27 are coupled together in a substantially non-separable way, for example first layer 26 being an adhesive and second layer 27 being made of paper or any kind of material on which an adhesive is applicable. In order to prepare web 5 prior to the printing process, which is not illustrated here, carrier material web 25 is attached with its adhesive layer 26 (first layer) to the second side 7 of printing material web 5 in a separable way so that carrier material web 25 can be removed from or separated from printing material web 5 after printing or any other post-treatment such as drying. The step of preparing printing material web 5 with the carrier material web 25 may be implemented in-line or off-line with respect to rotary offset printing machine 1. It shall also be noted that, particularly when printing on textiles, chemical and/or physical characteristics and parameters of the inks, dyes, pigments, colors etc. used for printing as well as chemical and/or physical characteristics and parameters of the printing material itself have a great influence on the achievable print result. Any know how or knowledge with respect to the chemical and/or physical characteristics and parameters of the inks, dyes, pigments, colors etc. used for printing as well as the chemical and/or physical characteristics and parameters of the printing material itself shall be enclosed herein by reference.

Application of carrier material web 25 to printing material web 5 at least for the duration of the printing process provides stabilization for the printing material web 5. For example, if printing material web 5 is made of a textile, printing on web 5 may lead to distortions in the printed image(s), due to the capability of inherent relative movement of web 5 to itself, i.e. movement of textile-fibers contained in web material relative to each other. Application of the carrier material web 25, however, reduces or prevents the capability of relative movement of the textile-fibers, and therefore reduces possible distortions of the images while being printed, and increases the “sharpness” or accuracy of the printed images.

However, although not shown here, other methods may be conceivable in order to provide stabilization for the printing material web 5, without the necessity to attach a carrier material web to the printing material web. For example, it may be possible to achieve stabilization of the printing material web by means of chemical and/or physical treatment of the printing material web prior to the printing process. After the printing process such chemical or physical treatment may be removed from the printing material web.

One advantage of the systems and/or methods described above is that a relatively high number of images can be printed with high accuracy and photo-like quality of the printed image in a relatively short period of time.

After the printing material web 5 has been rolled on to rewind reel 41, it is possible to further process the printing material web 5 in-line in order to manufacture respective items, for example for apparel-production.

Although the printing method is described above in terms of single-sided printing on the printing material web 5, it is also conceivable that on the reverse side of printing material web 5, i.e. the second side 7, may be printed after the first side 6 has been printed on. In this case, the steps of preparing the printing material web 5 in regards to stabilizing etc. apply likewise as described above. For instance, it may be possible to re-use the carrier material web 25 after it has been attached on the second side 7 of printing material layer 5. Of course, it is also possible to attach a different or new carrier material web to the first side 6 of printing material layer 5.

For the sake of brevity, conventional techniques related to industrial printing processes, and other functional aspects of the systems (and the individual operating components of the systems) may not be described in detail herein. It should be noted that many alternative or additional functional relationships or physical connections may be present in an embodiment of the subject matter.

Techniques and technologies may be described herein in terms of functional and/or logical block components and with reference to symbolic representations of operations, processing tasks, and functions that may be performed by various printing machine related components or devices. It should be appreciated that the various block components shown in the figures may be realized by any number of hardware, software, and/or firmware components configured to perform the specified functions. For example, an embodiment of a system or a component may employ various printing-process related components, e.g., web edge control, register control, fan-out control, slitters, turner bars, folding units or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

### Further Embodiments

1. A method for printing on a printing material web (5) by using a rotary offset printing machine (1), wherein the rotary offset printing machine (1) comprises at least one printing unit (10A) having at least two plate cylinders (15A, 16A), the method comprising the following steps:
   Providing the printing material web (5) having a first side (6) and a second side (7); wherein the printing material web (5) is treated to reduce or avoid an inherent relative movement to itself;
   Feeding the printing material web (5) into and through the at least one printing unit (10A); and
   Printing on the first side (6) of the printing material web (5) by means of a blanket cylinder (20A) on which respective images from the at least two plate cylinders (15A, 16A) have been transferred onto, wherein the at least two plate cylinders (15A, 16A) are arranged relative to each other with respect to their operation such that the images from the at least two plate cylinders (15A, 16A) are transferred to an identical position on the blanket cylinder (20A).
2. The method according to embodiment 1, further comprising, before the step of feeding the printing material web (5) into and through the at least one printing unit (10A), a step of providing a carrier material web (25) and a step of applying the carrier material web (25) to the second side (7) of the printing material web (5), in order to support the printing material web (5) at least during the steps of feeding and printing.
3. The method according to embodiment 2, wherein the carrier material web (25) comprises a first layer (26) and a second layer (27), wherein the second layer (27) is attached to the second side (7) of the printing material web (5) at least before the steps of feeding and printing are being performed.
4. The method according to embodiment 3, wherein the second layer (27) is an adhesive layer and the first layer (26) is a non-printable layer, both of which are attached to each other in a non-separable way.
5. The method according to one of embodiments 2 to 4, further comprising a step of chemically and/or physically and/or mechanically preparing the printing material web (5) at least before the step of applying the carrier material web (25) to the second side (7) of the printing material web (5) and before the step of printing, in order to improve a printing image quality on the first side (6) of the printing material web (5).
6. The method according to one of embodiments 1 to 5, wherein the at least one print unit (10A) comprises at least one inking unit (18A′), which is operatively coupled to the plate cylinders (15A, 16A).
7. The method according to one of embodiments 1 to 5, further comprising a step of printing on the second side (7) of the printing material web (5) by means of the blanket cylinder (20A) on which respective images from the at least two plate cylinders (15A, 16A) have been transferred onto, wherein the at least two plate cylinders (15A, 16A) are arranged relative to each other with respect to their operation such that the images of the at least two plate cylinders (15A, 16A) are transferred to an identical position on the blanket cylinder (20A).
8. The method according to embodiment 7, further comprising the following steps:
   After the step of printing on the first side (6) of the printing material web (5), removing the carrier material web (25) from the second side (7) of the printing material web (5), if the carrier material web (25) was applied; and
   Providing a carrier material web (25);
   Applying the carrier material web (25) to the first side (7) of the printing material web (5);
   Feeding the printing material web (5) including the carrier material web (25) into and through the at least one printing unit (10A); and
   Printing on the second side (7) of the printing material web (5) by means of the blanket cylinder (20A) on which respective images from the at least two plate cylinders (15A, 16A) have been transferred onto, wherein the at least two plate cylinders (15A, 16A) are arranged relative to each other with respect to their operation such that the images of the at least two plate cylinders (15A, 16A) are transferred to an identical position on the blanket cylinder (20A).
9. The method according to one of embodiments 1 to 8, further comprising, after the step of printing on the first side (6) of the printing material web (5) and/or printing on the second side (7) of the printing material web (5), feeding the printing material web (5) into and through a dryer unit (30).
10. The method according to one of embodiments 1 to 9, further comprising, after the step of printing on the first side (6) of the printing material web (5) and/or printing on the second side (7) of the printing material web (5), rolling the printing material web (5) onto a rewind reel unit (40).
11. The method according to one of embodiments 1 to 10, further comprising, before the step of feeding the printing material web (5) into and through the at least one printing unit (10A), rolling the printing material web (5) off from a roll-off feeder (50).
12. The method according to one of embodiments 1 to 11, further comprising a step of controlling a tension of the printing material web (5) and/or the carrier material web (25) by means of at least one web tension control unit (60).
13. The method according to one of embodiments 1 to 12, further comprising a step of providing a support belt (70), which is held in supporting contact with the printing material web (5) at least during the steps of feeding the printing material web (5) into and through the at least one printing unit (10A) and printing on either side (6, 7) of the printing material web (5).
14. The method according to embodiment 13, wherein the support belt (70) is guided by a plurality of impression cylinders (17A, 17B, 17C, 17D), wherein the impression cylinders (17A, 17B, 17C, 17D) are each arranged opposite to a respective blanket cylinder (20A, 20B, 20C, 20D) such that the step of printing onto the printing material web (5) is supported.
15. A rotary offset printing machine for printing on a printing material web (5), wherein the rotary offset printing machine comprises:
   at least one printing unit (10A), comprising:
   at least two plate cylinders (15A, 16A);
      at least one transfer cylinder (20A);
      at least one impression cylinder (17A) arranged opposite to the at least one transfer cylinder (20A); and
      at least one inking unit corresponding to one of the at least two plate cylinders (15A, 16A);
   wherein the at least two plate cylinders (15A, 16A) are arranged relative to each other with respect to their operation such that images from the at least two plate cylinders (15A, 16A) are transferred to an identical position on the blanket cylinder (20A); and
   wherein the at least one printing unit (10A) is configured to print on the printing material web (5), which is treated to reduce or avoid an inherent relative movement to itself.
16. The rotary offset printing machine according to embodiment 15, wherein the printing material web (5) comprises a first side (6) and a second side (7), wherein a carrier material web (25) having a first layer (26) and a second layer (27), wherein the first layer (26) is an adhesive, which is attached to the second layer (27) in a non-separable way, and wherein the first layer (26) is attached to the second side (7) of the printing material web (5) in a separable way.
17. The rotary offset printing machine according to embodiment 15 or 16, wherein the at least one print unit (10A) comprises at least one inking unit (18A′), which is operatively coupled to one of the plate cylinders (15A, 16A).
18. The rotary offset printing machine according to one of embodiments 15 to 17, further comprising a dryer unit (30), which is arranged in line with the at least one print unit (10A).
19. The rotary offset printing machine according to one of embodiments 15 to 18, further comprising a roll-off feeder (50) and/or a rewind reel unit (40), which are arranged in line with the at least one print unit (10A).
20. The rotary offset printing machine according to one of embodiments 15 to 19, further comprising at least one web tension control unit (60) for controlling a tension of the printing material web (5) and/or the carrier material web (25).
21. The rotary offset printing machine according to one of embodiments 15 to 20, further comprising a support belt (70), which is held in supporting contact with the printing material web (5).
22. The rotary offset printing machine according to one of embodiments 15 to 21, wherein the support belt (70) is guided by a plurality of impression cylinders (17A, 17B, 17C, 170), wherein the impression cylinders (17A, 17B, 17C, 17D) are each arranged opposite to a respective blanket cylinder (20A, 20B, 20C, 20D).

1.-22. (canceled)

23. A method for printing on a printing material web by using a rotary offset printing machine, wherein the rotary offset printing machine includes at least one printing unit having at least two plate cylinders, comprising the steps of:
feeding the printing material web into and through the at least one printing unit, wherein the printing material web has a first side and a second side and wherein the printing material web is treated to reduce or avoid an inherent relative movement to itself; and
printing on the first side of the printing material web by a blanket cylinder on which respective images from the at least two plate cylinders have been transferred onto, wherein the at least two plate cylinders are arranged relative to each other with respect to their operation such that the images from the at least two plate cylinders are transferred to an identical position on the blanket cylinder.

24. The method according to claim 23, wherein before the step of feeding the printing material web into and through the at least one printing unit, further comprising the step of applying a carrier material web to the second side of the printing material web to support the printing material web at least during the steps of feeding and printing.

25. The method according to claim 24, wherein the carrier material web comprises a first layer and a second layer, wherein the second layer is attached to the second side of the printing material web.

26. The method according to claim 25, wherein the second layer is an adhesive layer and the first layer is a non-printable layer and wherein the second layer and the first layer are attached to each other in a non-separable manner.

27. The method according to claim 24, further comprising the step of chemically and/or physically and/or mechanically preparing the printing material web at least before the step of applying the carrier material web to the second side of the printing material web and before the step of printing in order to improve a printing image quality on the first side of the printing material web.

28. The method according to claim 23, wherein the at least one printing unit further includes at least one inking unit which is operatively coupled to the at least two plate cylinders.

29. The method according to claim 23, further comprising the step of printing on the second side of the printing material web by the blanket cylinder on which respective images from the at least two plate cylinders have been transferred onto, wherein the at least two plate cylinders are arranged relative to each other with respect to their operation such that the images from the at least two plate cylinders are transferred to an identical position on the blanket cylinder.

30. The method according to claim 29, further comprising the step of, after the step of printing on the first side of the printing material web, applying a carrier material web to the first side of the printing material web.

31. The method according to claim 29, wherein, after the step of printing on the first side of the printing material web and/or printing on the second side of the printing material web, further comprising the step of feeding the printing material web into and through a dryer unit.

32. The method according to claim 29, wherein, after the step of printing on the first side of the printing material web and/or printing on the second side of the printing material web, further comprising the step of rolling the printing material web onto a rewind reel unit.

33. The method according to claim 23, wherein, before the step of feeding the printing material web into and through the at least one printing unit, further comprising the step of rolling the printing material web off from a roll-off feeder.

34. The method according to claim 24, further comprising the step of controlling a tension of the printing material web and/or the carrier material web by at least one web tension control unit.

35. The method according to claim 23, further comprising the step of providing a support belt which is held in supporting contact with the printing material web at least during the steps of feeding the printing material web into and through the at least one printing unit and printing on the first side of the printing material web.

36. The method according to claim 35, wherein the support belt is guided by a plurality of impression cylinders, wherein the plurality of impression cylinders are each arranged opposite to a respective blanket cylinder.

37. A rotary offset printing machine for printing on a printing material web, comprising:
at least one printing unit, including:
at least two plate cylinders;
at least one blanket cylinder;
at least one impression cylinder arranged opposite to the at least one blanket cylinder; and
at least one inking unit corresponding to one of the at least two plate cylinders;
wherein the at least two plate cylinders are arranged relative to each other with respect to their operation such that images from the at least two plate cylinders are transferrable to an identical position on the blanket cylinder;
and wherein the at least one printing unit is configured to print on the printing material web which is treated to reduce or avoid an inherent relative movement to itself.

38. The rotary offset printing machine according to claim 37 in combination with the printing material web, wherein the printing material web includes a first side, a second side, and a carrier material web, wherein the carrier material web has a first layer and a second layer, wherein the second layer is an adhesive and is attached to the first layer in a non-separable manner, and wherein the second layer is attached to the second side of the printing material web in a separable manner.

39. The rotary offset printing machine according to claim 37, wherein the at least one printing unit includes at least one inking unit which is operatively coupled to one of the at least two plate cylinders.

40. The rotary offset printing machine according claim 37, further comprising a dryer unit which is arranged in line with the at least one printing unit.

41. The rotary offset printing machine according to claim 37, further comprising a roll-off feeder and/or a rewind reel unit which are arranged in line with the at least one printing unit.

42. The rotary offset printing machine according to claim 38 in combination with the printing material web, further comprising at least one web tension control unit for controlling a tension of the printing material web and/or the carrier material web.

43. The rotary offset printing machine according to claim 37 in combination with the printing material web, further comprising a support belt which is held in supporting contact with the printing material web.

44. The rotary offset printing machine according to claim 43, wherein the support belt is guided by a plurality of impression cylinders, wherein the impression cylinders are each arranged opposite to a respective blanket cylinder.

45. A method for printing on a printing material web by using a rotary offset printing machine, wherein the rotary offset printing machine includes a printing unit with two plate cylinders and a blanket cylinder, comprising the steps of:
feeding the printing material web into and through the printing unit; and
printing on the printing material web by the blanket cylinder, wherein the two plate cylinders are arranged relative to each other such that respective images from the two plate cylinders are transferred to an identical position on the blanket cylinder during the printing.

46. A rotary offset printing machine for printing on a printing material web, comprising:
a printing unit, including:
two plate cylinders;
a blanket cylinder;
an impression cylinder arranged opposite to the blanket cylinder; and
an inking unit corresponding to one of the two plate cylinders;
wherein the two plate cylinders are arranged relative to each other such that respective images from the two plate cylinders are transferrable to an identical position on the blanket cylinder.
